(19) United States
(12) Patent Application Publication
(10) Pub. No.: US 2017/0293923 A1
(43) Pub. Date: Oct. 12, 2017

(54) WELLNESS PROGRAM CURATION

(71) Applicant: Welltok, Inc., Denver, CO (US)

(72) Inventors: Jeffrey H. Margolis, Newport Beach, CA (US); Travis McElfresh, Redmond, WA (US); Jeff Cohen, Clinton, CT (US)

(21) Appl. No.: 15/097,108

(22) Filed: Apr. 12, 2016

(51) Int. Cl. G06Q 30/02

(52) U.S. Cl. CPC G06Q 30/0204

(57) ABSTRACT

A system to assist users with the selection of and participation in wellness programs. The system assists a user in selecting wellness programs by recommending a curated set of wellness programs to the user. In recommending a curated set of wellness programs that a user can select, the system analyzes several factors. Some of the factors used in recommending wellness programs include user data, a population segment associated with a user, sponsor criteria, the likelihood that the user will be successful in recommended wellness programs, and user preferences.

### BACKGROUND

A wellness program is a program typically offered by an employer, healthcare provider, or insurance company that is intended to improve and promote the health of employees and individuals. Wellness programs include activities such as participating in sponsored exercise, joining weight-loss competitions, attending diabetes management lectures, listening to educational seminars, and reading tobacco cessation literature. Wellness programs may also include health screenings that are designed to monitor physical health, such as blood pressure or glucose levels.

An employer, healthcare provider, insurance company or other party controlling access to wellness programs (collectively, “sponsors”) can offer a wellness program or a suite of wellness programs to users such as an employee or an insured party. Wellness programs are often administered via a service platform such as a website or an application. For example, a user can use a mobile application provided by his or her employer to access and participate in wellness programs. In such an example, a user can download the mobile application, register using a screen name linked to a work email address, and select certain wellness programs in which to participate. Alternatively, a user can use a desktop or laptop to access a website and register for a service that provides wellness programs. The service can provide a list of wellness programs for a user, allowing the user to select desired programs in which to participate. For example, a working father may have a few fitness goals such as reducing stress, losing weight, and managing diabetes. He can access a website provided by a business that offers wellness programs to accomplish his goals.

Wellness programs can take a variety of forms, but typically are associated with one or more goals. Each goal is defined by one or more tasks that are to be completed within a certain timeframe. For example, the overall goal of a wellness program may be to reduce stress during a one-week period. The tasks in the wellness program may be to take a five-minute walk outside during the workday, to watch a short instructional video on stress reduction, or to journal thoughts at the end of each day. As another example, the goal of a wellness program may be to lower blood pressure. The tasks can include avoiding foods that may cause high blood pressure and regularly (e.g., 15 minutes/day) performing a cardiovascular exercise such as running or cycling over a one-month period. In such an example, a user can track progress in completing the wellness program by recording task progress or completion using a mobile application.

Unfortunately, people struggle to effectively use wellness programs. One reason people struggle with wellness programs is because they are overwhelmed with the choices and options for wellness programs (e.g., hundreds of wellness programs provided by an employer), which discourages people from using the wellness programs. For example, a health insurance company might provide a suite of more than 150 wellness programs that cover a continuum of care from self-help activities to coached activities or group activities. The wide variety of choices overwhelms a user. If a user simply wants to reduce stress, he may become discouraged or distracted by the number of wellness programs.

Another issue is that wellness programs are often generic and directed toward the general public. For example, a wellness program to reduce stress may encourage people to join a yoga class. However, some people dislike yoga and, therefore, the program does not help these people accomplish the goal of reducing stress. Ultimately, while wellness programs are a great resource, the programs often fail to achieve intended results, which leaves sponsors and users unsatisfied.

The need exists for systems and methods that overcome the above problems, as well as provide additional benefits. Other limitations of existing or prior systems will become apparent to those of ordinary skill in the art upon reading the following Detailed Description.

### BRIEF DESCRIPTION OF THE DRAWINGS

FIG. 1 is a block diagram illustrating an overview of a device on which some implementations of the disclosed system for providing a curated list of wellness programs operate.

FIG. 2 is a block diagram illustrating a representative environment in which the disclosed system operates.

FIG. 3 depicts a representative table with relevant wellness program data.

FIG. 4 is a flow diagram illustrating a process for providing a curated list of recommended wellness programs for a user.

FIGS. 5, 6, and 7A-7B are example graphical interfaces for the disclosed system.

The techniques introduced in this disclosure can be better understood by referring to the following Detailed Description in conjunction with the accompanying drawings.

### DETAILED DESCRIPTION

A system to assist users with the selection of wellness programs is disclosed herein. The system assists users in selecting wellness programs by recommending only certain wellness programs to a user. For example, a user may have goals to quit smoking and lose weight. While there might be multiple wellness programs (e.g., >50) that can help the user accomplish these goals, the system can recommend a smaller number of wellness programs (e.g., <10) that are more likely to help the user achieve these goals. Although presented with multiple options, the user can elect to enroll in many of the recommended programs or to enroll in just one program.

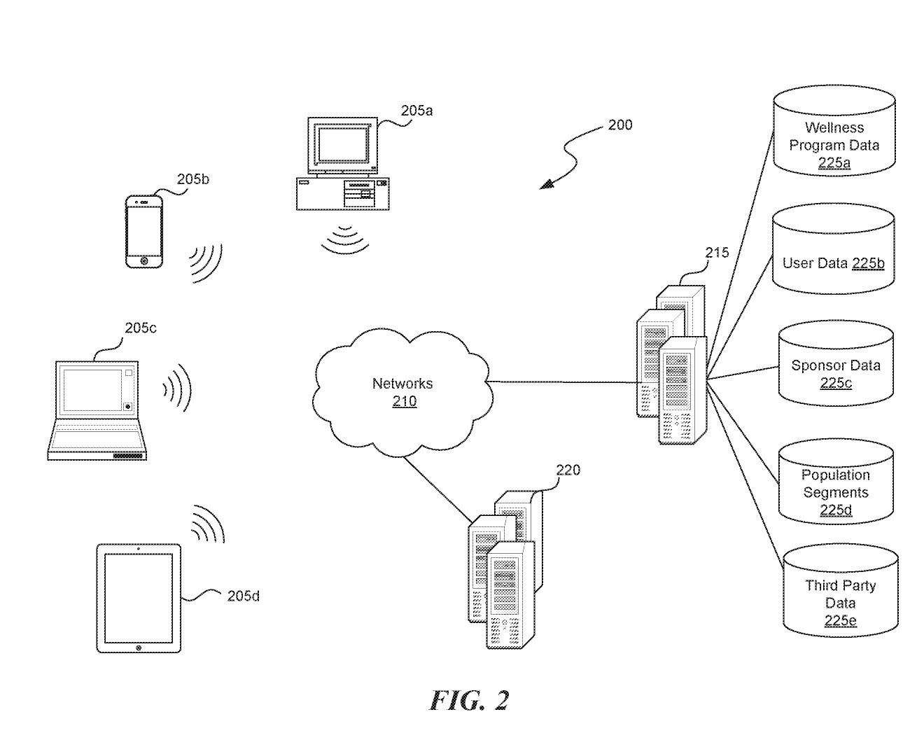

To identify wellness programs to recommend to the user, the system analyzes several factors. Some of the factors used in recommending wellness programs include data that characterizes the user (e.g., the user's medical conditions, age, weight), characteristics of a population segment into which the user is assigned, sponsor criteria associated with the user (e.g., whether the user is a full-time or part-time employee and therefore subject to different coverage), the likelihood that a user will complete a wellness program based on historical success rates, and user preferences. Using these factors, the system can search a dataset of wellness programs to identify wellness programs to recommend to a user. Further details regarding the analysis of factors used to make a recommendation are described with respect to FIGS. 2-5.

In a representative use of the system, the system receives information about a user (e.g., age, height, weight, medical conditions), determines a population segment that corresponds to the user (e.g., a 50- to 60-year-old healthy individual who is not getting enough sleep), determines a keyword or keywords associated with the population segment (e.g., sleep deprivation, dehydrated, stressed), and searches a database of wellness programs with the keyword or keywords. In response to the search, the system receives search results that identify a set of wellness programs. The system filters the resulting set of wellness programs based on sponsor data, historical success rates of the wellness programs, and user preferences. Based on the searching and filtering, the system presents a curated set of recommended wellness programs to a user and receives user selections of wellness programs. After receiving user selections, the system provides an itinerary of wellness programs to the user.

There are several advantages to the disclosed system. First, the system can improve the motivation and focus of wellness program participants. By recommending wellness programs that a user can select and limiting the number of wellness programs presented to a user, the system prevents the user from being overwhelmed with choices. Second, the system customizes a user's experience, which can help motivate the user. For example, rather than presenting all wellness programs that are designed for a general population, the system will provide the user with wellness programs that match the user's capabilities and interests. By doing so, the user may be more inclined to complete the suggested wellness programs. Overall, the system enables sponsors to target, engage, motivate, and guide a group of individuals to meet goals. Other advantages will be apparent to those having ordinary skill in the art when reading the Detailed Description.

In this Detailed Description, the following terms have a particular meaning. In general, an “itinerary” is defined as a user-selected set of wellness programs. By accessing the itinerary, a user is able to obtain information about each wellness program in the itinerary and the tasks associated with each wellness program. The itinerary can be visually represented as a list or group of wellness programs or stored in database. For example, the system can provide a wellness program itinerary to a user in an interactive graphical interface on an iPhone™. Also, in general, the term “filter” is defined as removing elements from a dataset based on one or more criteria. For example, in making a recommendation for a woman, the system can filter or remove wellness programs recommended for males from a set of wellness programs designed for both men and women. Additionally, a “curated list” or “curated set” is defined as a tailored list or set of wellness programs prepared for a particular user. For example, the system can provide a curated set of five wellness programs with goals of weight loss and diabetes management for a user who is overweight and managing diabetes.

Various implementations of the system will now be described. The following description provides specific details for a thorough understanding and an enabling description of these implementations. One skilled in the art will understand, however, that the system may be practiced without many of these details. Additionally, some well-known structures or functions may not be shown or described in detail so as to avoid unnecessarily obscuring the relevant description of the various implementations. The terminology used in the description presented below is intended to be interpreted in its broadest reasonable manner, even though it is being used in conjunction with a detailed description of certain specific implementations of the system.

### Suitable Device

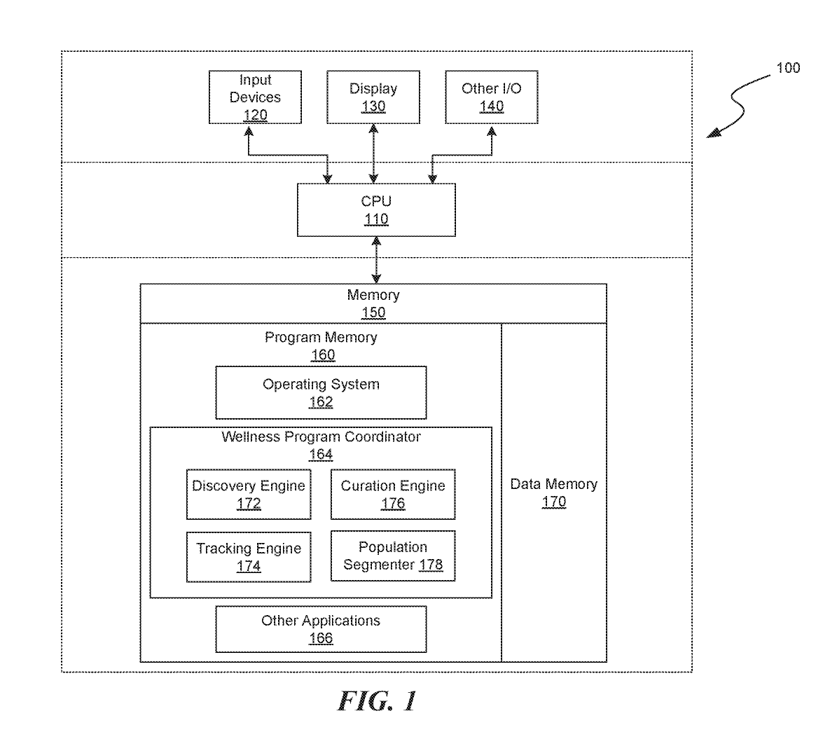

FIG. 1 is a block diagram illustrating an overview of a device on which some implementations of the system operate to recommend wellness programs to a user. Device 100 can be a personal computer, server, laptop, smartphone (e.g., an iPhone™), wearable electronic device, tablet device, mobile device, or other microprocessor-based system or programmable consumer electronic device. Device 100 includes a central processing unit (CPU) 110 and one or more input devices 120. Input devices 120 can include a mouse, keyboard, touchscreen, infrared sensor, touchpad, wearable input device, camera, medical sensor, or microphone.

CPU 110 can be a single processing unit or multiple processing units in a device or distributed across multiple devices. CPU 110 can be coupled to other hardware devices, for example, via a small computer system interface (SCSI) bus. CPU 110 can communicate with a hardware controller for devices, such as to a display 130 that is used to display text and graphics. In some implementations, display 130 provides graphical and textual feedback to a user. For example, a user can view recommended wellness programs, a wellness program itinerary, and completed tasks for each wellness program. In some implementations, the display 130 is separate from the input device 120. Examples of display devices are an LCD display screen, an LED display screen, or an augmented reality display (e.g., a head-mounted device). Other input/output (I/O) devices 140 can also be coupled to the CPU 110, such as a network card, video card, audio card, USB, FireWire or other external device, camera, printer, speakers, flash memory card, CD-ROM drive, or DVD drive.

The device 100 also includes a communication component (not shown in FIG. 1) for wireless and wire-based communication. For example, the device 100 can communicate using the Institute of Electrical and Electronics Engineers (IEEE) 802.11 wireless communication standards. The communication component can communicate with another device or a server through a network using, for example, TCP/IP protocols.

CPU 110 can access memory 150. Memory 150 includes one or more of various hardware devices for volatile and non-volatile storage, and can include both read-only and writable memory. For example, memory 150 can comprise random access memory (RAM), CPU registers, read-only memory (ROM), and writable non-volatile memory, such as flash memory, hard drives, magnetic storage devices, and device buffers.

Memory 150 can also include computer-executable instructions, such as routines executed by the CPU. Memory 150 can include program memory 160 that stores programs and software, such as an operating system 162, wellness program coordinator 164 (described in more detail below), and other application programs 166. In some implementations, program memory 160 includes algorithms such as a clustering algorithm or closest-fit algorithm. Memory 150 also includes data memory 170 that is used to store such user data as passwords, usernames, input text, audio, video, user preferences, configuration data, settings, user options, and time stamps. Data in data memory 170 can be read, modified, and deleted by the CPU.

As shown in FIG. 1, device 100 includes a wellness program coordinator 164 with discovery engine 172, tracking engine 174, curation engine 176, and population segmenter 178 modules. These modules execute methods or functions of the system described herein, and can include subcomponents or other logical entities that assist with or enable the performance of some or all of these methods or functions. These modules can communicate with each other, meaning that they share data and analysis results between modules. The operation of each module will be described briefly, followed by a more detailed explanation of the overall system operation with respect to FIGS. 2-7B.

As an overview, the discovery engine 172 gathers information about a user. The discovery engine 172 may gather information directly from a user using a questionnaire, series of questions, or other method that are presented to a user on a computing device. Such information may include common metrics about an individual, including the user's height, weight, age, existing medical conditions (e.g., heart disease, diabetes, depression), wellness goals, or other user characteristics. The discovery engine 172 may also retrieve information about a user from outside services. To access outside services, the discovery engine 172 can utilize various application program interfaces (APIs) to access data stored in other sources. As such, the discovery engine 172 may periodically request or receive updates to information about the user from various other services. With a user's permission, for example, the discovery engine 172 can also access the user's medical records to obtain current medical records. To access medical records, the user may be required to provide the system their login information for a health record source.

In addition to gathering information before a user starts a wellness program, the discovery engine 172 can also gather information about a user during a wellness program or after the completion of a wellness program. For example, if the user signed up for a basic set of wellness programs and completed several tasks within those programs, using a series of questions presented on a computing device, the discovery engine 172 may ask the user about his or her experience with the tasks to gather information about the likes and dislikes of the user (capturing the user's preferences are described in more detail in FIG. 2). As another example, after a user completes a program, the discovery engine 172 can ask a user if he or she is satisfied with the program. For example, the discovery engine 172 can ask a user to rate a wellness program on a scale of one to five, where one is very dissatisfied and five is very satisfied.

In addition to data received directly from the user or data received from other services, the discovery engine 172 may also receive information from devices associated with the user that may be used to characterize the state of the user. If the user grants permission, the discovery engine 172 can determine the location of the user by accessing or receiving location information from the user's computing device 100. For example, the discovery engine 172 may receive GPS information transmitted from the user's smartphone or smart watch. Using the location information, the discovery engine 172 can estimate weather conditions near the user using a local weather service.

The tracking engine 174 gathers information related to a user's performance during a wellness program. In some implementations, the tracking engine 174 monitors the number of tasks that a user has completed for a wellness program and the time it took the user to complete the tasks. For example, a tobacco-cessation program may suggest that a user complete three tasks to finish the wellness program: watch a video, answer some basic questions, and take an online quiz. In such an example, the tracking engine 174 can gather information about whether the user has watched the video and when the user watched the video.

In general, the population segmenter 178 analyzes user characteristics to categorize the user into a particular population segment. User characteristics can include, but is not limited to, data about the user such as medical conditions, age, weight, location, health care coverage, and capability. For example, a user may be a 49 year-old male, weigh 190 pounds, have diabetes, and be a tobacco user. The population segmenter 178 places users into a population segment with other like users. As will be described in additional detail herein, the population segment of a user is used to determine which wellness programs to recommend to the user.

One advantage of assigning users to a particular population segment is that doing so can keep the user identity anonymous and protect certain confidential medical information. For example, while employers may want to encourage employees to submit blood pressure and other medical results for wellness programs, the employers must comply with the Health Insurance Portability and Accountability Act (HIPAA). The population segmenter 178 allows a user to be matched with a population segment while not sharing specific details of the user's medical record. By masking certain personal information about a user and making recommendations to the user using information about a general segment of the population, the population segmenter 178 can assist employers in complying with HIPAA and other regulations.

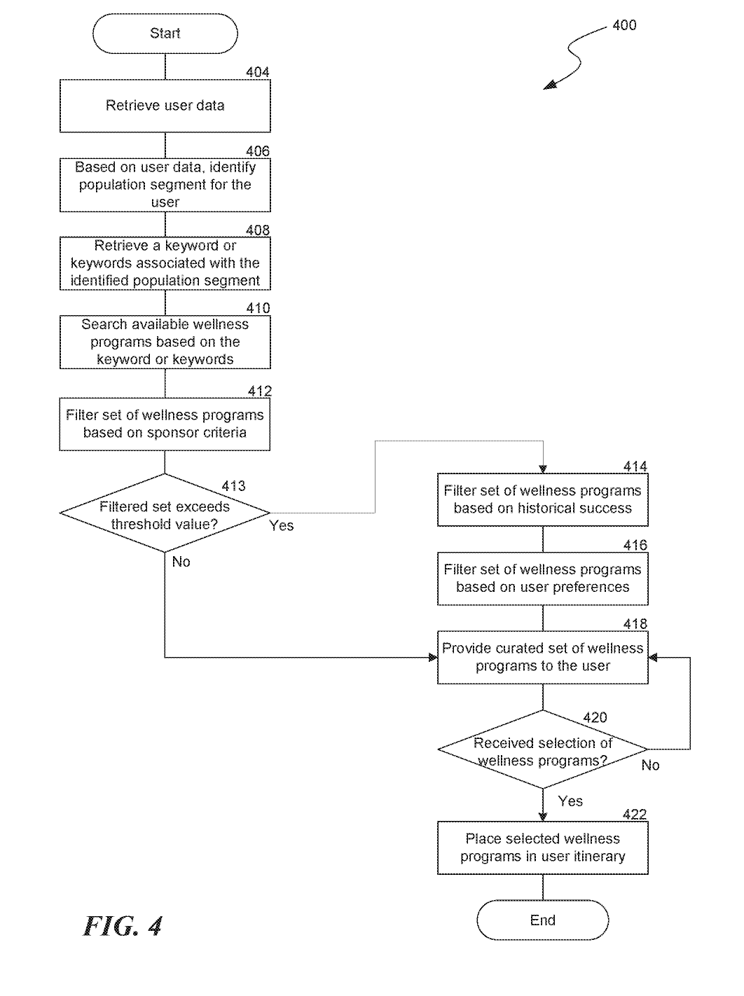

The curation engine 176 implements algorithms to determine which wellness programs should be recommended to a user. In some implementations, the curation engine 176 uses four factors to determine which wellness program to recommend. The four factors are: (1) population segment, (2) sponsor criteria, (3) historical success in wellness program completion, and (4) user preferences. A brief description of each of these factors is set forth below. Each of these factors is described in more detail in FIG. 2 with respect to the datasets related to these factors and in FIG. 4 with respect to how the system uses the factors.

Based on a population segment that a user is assigned to, the curation engine 176 will recommend certain wellness programs over others. Each population segment has a defining characteristic or characteristics (e.g., old, young, diabetic), and the curation engine 176 uses the characteristics of a population segment to determine those wellness programs that are suitable for the user. In addition to using information about the population segment to make a wellness program recommendation, the recommended wellness program may also depend on other characteristics of the user in formulating the recommendation.

In addition to recommending wellness programs based on a population segment associated with a user, the curation engine 176 uses sponsor criteria to modify those wellness programs that are offered to the user. Sponsor criteria are criteria that determine a user's eligibility to participate in a wellness program. The sponsor criteria may be specified as one or more positive or negative rules that determine whether a particular wellness program is accessible to a particular user. For example, a sponsor may have identified certain wellness programs that should be recommended to certain user population because the wellness programs are known to be particularly effective for that population. The sponsor may also have other wellness programs that should not be recommended to certain users because the wellness programs are not covered by the user's health insurance. Sponsor criteria can be implemented by application of certain tags to wellness programs. For example, a sponsor may want to offer a certain set of wellness programs to executive level employees and a different set of wellness programs to all non-executive employees. In such an example, each program can be tagged with “executive level” or “non-executive level” tags. When making recommendations, the system utilizes the tags to determine which programs should be included or excluded from any recommendation.

In addition to modifying wellness program recommendations based on sponsor criteria, the curation engine 176 further modifies its recommendations based on the historical success rate of completing a wellness program by the user or by similar users. The curation engine 176 can calculate a historical success rate for a user based on the user having successfully completed similar wellness programs in the past. The curation engine 176 identifies similar wellness programs that have been previously completed by a user based on the wellness programs having similar characterizing keywords. The curation engine 176 may also identify similar wellness programs based on the wellness programs having one or more similar tasks. After identifying similar wellness programs, the curation engine 176 assesses whether the user successfully completed the similar wellness programs in the past. The greater the completion rate of past similar wellness programs, the higher the likelihood that the user will complete a newly-recommended wellness program. For example, if a user has successfully completed a task involving daily walking in one wellness program, the curation engine 176 may be more likely to recommend other wellness programs involving daily walking.

Alternatively, the curation engine 176 can estimate a historical success rate for a user based on the historical success rate of other users that are similar to the user. If other users in a user's population segment successfully completed similar wellness programs in the past, then the curation engine 176 may judge that the current user will be more likely to complete the recommended wellness program. For example, if 90% of a population segment has successfully completed a wellness program for drinking more water, the curation engine 176 may determine that a user that falls in that population segment likely has a higher probability of completing that wellness program.

In addition to modifying wellness program recommendations based on historical success rates, the curation engine 176 further modifies wellness program recommendations based on user preferences. The curation engine 176 uses user preferences, such as a user's likes and dislikes, gathered by the discovery engine 172 to make recommendations. For example, the curation engine 176 can use information about the type of wellness program tasks that a user likes to promote wellness programs having similar tasks. The curation engine 176 may similarly use information about the type of wellness program tasks that a user doesn't like to demote remove wellness programs from being presented to the user.

### Suitable Environment

FIG. 2 is a block diagram illustrating an overview of an environment 200 in which implementations of the disclosed system can operate. Environment 200 includes one or more computing devices 205a-d. Computing devices 205a-d can be a desktop computer 205a, a mobile phone 205b, a laptop computer 205c, a tablet 205d, a wearable device such as a smartwatch (not shown), etc. Computing devices 205a-d communicate over networks 210 to system servers 215. The system servers 215 can be single servers or may be part of a distributed computing environment encompassing multiple computing devices located at the same or at geographically disparate physical locations. Those skilled in the relevant art will further recognize that certain portions of the system may reside on one or more system servers 215, while other portions reside on the computing devices 205a-d. System servers 215 may communicate with one or more third party services, represented by servers 220.

Networks 210 allow for communication in environment 200. Networks 210 may include wireless networks such as, but not limited to, one or more of a Local Area Network (LAN), Wireless Local Area Network (WLAN), a Wide Area Network (WAN), Global System for Mobile Communications (GSM), Bluetooth, WiFi, Fixed Wireless Data, 2G, 2.5G, 3G, 4G, 5G, LTE networks, using messaging protocols such as TCP/IP, SMS, MMS, or any other wireless data networks or messaging protocols. Networks 210 may also include wired networks.

To facilitate providing a curated list of wellness programs to a user, the system accesses one or more datasets, including: a wellness program dataset 225a, a user dataset 225b, a sponsor dataset 225c, a population segment dataset 225d, and a third party dataset 225e. System modules can store information in these datasets or update information in these datasets continuously, periodically, or sporadically.

The wellness program dataset 225a is a dataset that stores data and metadata related to each wellness program. A medical group or sponsor (e.g., an employer, insurance company, medical device, or service provider) can host or create the wellness program dataset 225a and provide access to the dataset. For each of the wellness programs, the dataset includes a description of the wellness program as well as one or more tasks that are associated with the wellness program. For example, a task might be to exercise for a certain period, to watch a short video, to answer a short quiz, to stretch once a day, etc. Also, the wellness program dataset 225a stores wellness program metadata that characterizes the wellness programs. For example, the metadata may include recommended characteristics of users that should participate in the wellness program. Such characteristics may include recommended gender, age, and required capability of individuals to perform tasks in a wellness program.

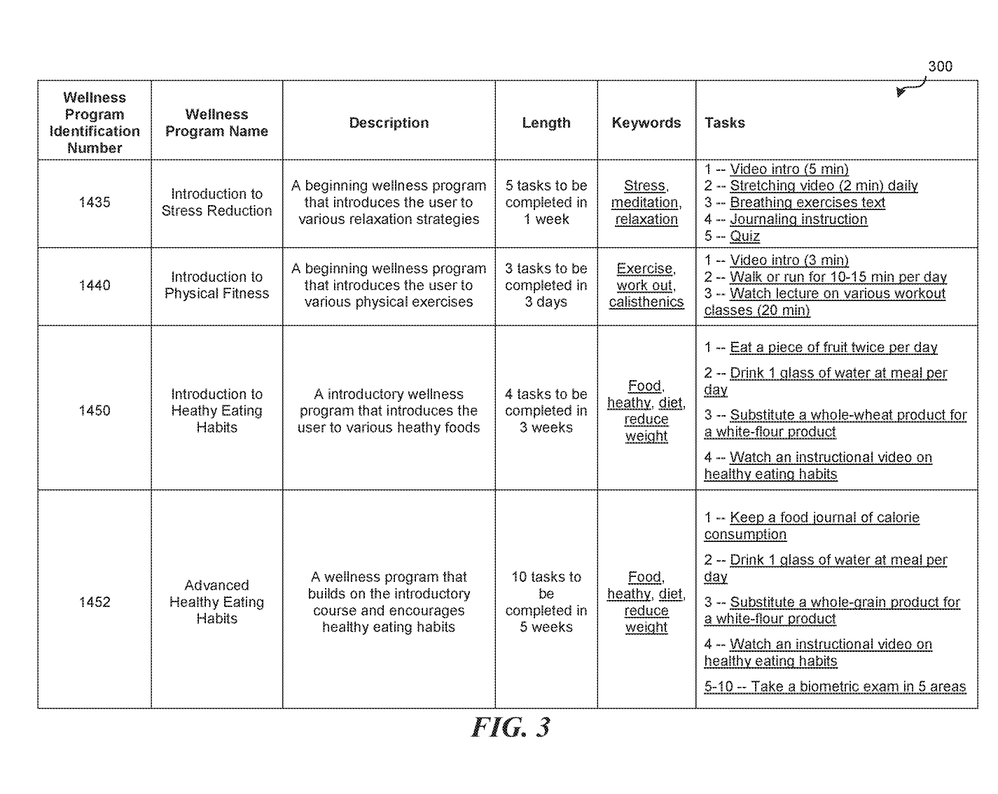

As part of the metadata that is stored about wellness programs, the wellness program dataset 225a also contains a keyword or keywords characterizing each wellness program and/or the medical conditions that the wellness program is intended to address. For example, a wellness program for diabetics may be associated with the keywords: “blood sugar,” “diabetes type 1 and 2,” or “weight control related to diabetes.” In some implementations, a wellness program is associated with a single keyword. For example, a wellness program to increase muscle mass can be associated with “strength.” In general, keywords can be very narrow (e.g., “improving happiness in people with clinical depression”) or broad (e.g., “reduce stress”). Wellness program data 225a can be arranged in a table, as described below with respect to FIG. 3.

FIG. 3 depicts a representative wellness program table 300 that includes information about each wellness program. Each row in the table reflects a wellness program. Each column in the table contains data characterizing the wellness program. Some stored characteristics of wellness programs can be the wellness program name, brief description of the program, a length of the program, keywords characterizing the wellness program, and a list of tasks associated with the program. While table 300 represents wellness programs in a table format, the wellness data may be stored in a different format (e.g., in a tree structure). Moreover, the table may include links to data stored elsewhere. For example, as shown by underlining in table 300, some words are links or pointers to more information, such as detailed information about a particular task. The details about each task may include instructions and other content that is provided by the wellness program to the user to characterize the task. Also, while not shown in FIG. 3, wellness program table 300 can store information that indicates a wellness program is similar to another wellness program. In some implementations, wellness programs are similar if the keywords characterizing the wellness programs are the same or differ by a limited number of words. In some implementations, the table contains links or pointers to other similar wellness programs.

Returning to FIG. 2, the user dataset 225b is a dataset that stores information about a user. The user dataset includes general information characterizing the individual, such as the user's gender, age, weight, and height. User dataset 225b also includes data about a user's preferences and goals. The user dataset 225b also stores information about the current state of the user, such as the physical location of the user. Additionally, in some implementations, user dataset 225b stores details about the user's past or present participation in wellness programs. With respect to past wellness programs, the user dataset 225b may contain a list of all wellness programs that a user selected and a record of whether the user successfully completed each selected wellness program. For those wellness programs that were successfully completed by the user, the user dataset may contain feedback from the user as to whether they liked or disliked the overall wellness program and/or individual tasks in the wellness program. With respect to current wellness programs, the user dataset 225b may contain a record of the tasks that have been completed in selected wellness programs and the tasks that remain to be completed. The information about each user in the user dataset 225b may be organized in a profile that characterizes each user.

Sponsor dataset 225c is a dataset that stores sponsor criteria. A sponsor is an employer, healthcare provider, insurance company or other party controlling access to wellness programs by the user. A sponsor dataset 225c can have sponsor criteria that relates to enrollment requirements for wellness programs. One example of sponsor criteria is a sponsor goal, which may vary by employer or organization. A sponsor goal may include, for example, reducing insurance costs, preventing workplace injuries, elevating employee happiness, improving employee balance for jobs demanding physical exertion, or other mental or physical goals. Sponsor criteria may be common across all of the sponsor's users, or the sponsor criteria may be configured on a per-population segment, per-user location, or other basis.

Another example of sponsor criteria are access rules that apply to different groups of individuals. Individuals might be grouped by, for example, employment title or position, employment compensation, or office location. Each group allows a sponsor to distinguish between the services that it offers to different enrolled users. For example, sponsors can design wellness programs with a two-tiered structure. The first tier programs might be offered to executives at a company, and the second tier may be offered to all other employees at the company. Other groups might be generated for full-time, part-time, retired, corporate, or premium employees. Still other groups might be generated for employer offices located in one location (e.g., the U.S. Southeast) as compared to another location (e.g., the U.S. Northeast).

Population segment dataset 225d stores information about segments of the population. Segments can be broad, such as a segment for all individuals between the ages of 50 and 60 years old, or the segments can also be narrow, such as females living with diabetes and depression who are between 35 and 50 years old. In some implementations, the system receives information for the population segment dataset 225d from an organization or company. For example, the Mayo Clinic™ Health System can provide population segment data for the United States, wherein the data is grouped into several segments according to certain characteristics of the population, such as age, gender, health conditions, health concerns, and health goals. Such segmentation is often performed by actuaries or engineers based on large datasets.

Alternatively, in some implementations, the segments of the population can be constructed by the system based on the data in the user dataset 225b. Specifically, the population segment dataset 225d can be created by analyzing received user data for a population of users. For example, the system may gather data about a set of employees, using questions answered by the employees and health data collected about the employees. Then, the system uses the employee data and a clustering algorithm to segment the employees into different population segments. One suitable algorithm that the system might use is to generate a multi-vector characterization of each user based on characteristics of the user. Each user vector is then compared by the system to other user vectors using a least distance algorithm. Users having like vectors are grouped into clusters. Another algorithm is for the system to apply a BIRCH clustering algorithm to the set of employee data. Using such a methodology, the system can determine, for example, that one segment of the employee population is overweight and stressed, and another segment is underweight and lacking in endurance. As will be described herein, each population segment may be targeted with different wellness programs.

In addition to characteristics related to population segments, population segment dataset 225d stores an average percent success rate of a population segment for a particular wellness program. Each success rate can be linked or tagged to a population segment for a particular wellness program. The system can calculate an average percent success rate for a population segment using Equation 1 below, where, for each user in a population segment, the number of tasks a user completed is divided by the total number of tasks in a wellness program.

$$\frac{{\sum }_{n = 1}^{n users} ( \frac{\begin{matrix}number of tasks completed by a \\ user for a wellness program\end{matrix}}{\begin{matrix}total number of tasks to complete \\ the wellness program\end{matrix}} )}{\begin{matrix}number of users in a population segment \\ who enrolled in the wellness program\end{matrix}} \times 100 = Average percent success rate for a populaton segment for a wellness program {(}^{″} success {rate}^{″} ) \qquad Equation ( 1 )$$

Additionally, population segment dataset 225d stores the success rate in a table, as shown below in table 1.

TABLE 1
Wellness Program Success Rates for a Population Segment

| Success rates | Wellness | Wellness | Wellness |
|---|---|---|---|
| for Population | Program 1 | Program 2 | Program 3 |
| Segments | Success Rate | Success Rate | Success Rate |
| Segment A | 80% | 85% | 99% |
| (overweight, diabetic) | | | |
| Segment B | 40% | 92% | 75% |
| (young women who want to | | | |
| reduce stress) | | | |
| Segment C | 90% | 95% | 91% |
| (healthy men with arthritis) | | | |
| Segment D | 92% | 91% | 40% |
| (depressed, male employees | | | |
| who want to improve | | | |
| happiness) | | | |

In addition to the datasets described above, the system also maintains a third party dataset 225e. The third party dataset contains any other data that the system might receive from parties such as hospitals, healthcare providers, and businesses, that might be used to recommend wellness programs to users. The third party data may be locally stored by the system, or may be remotely hosted by the third party data provider and accessed by the system via APIs.

### Flow Diagram Illustrating Example Process

FIG. 4 is a flow diagram illustrating a process 400 implemented by the system for generating a set of wellness program recommendations for a user. Process 400 is repeated by the system for each user analyzed by the system. In general, process 400 includes receiving information about a user (e.g., height, weight, goals, medical condition), determining a population segment that corresponds to the user; determining a keyword or keywords associated with a population segment; searching for a set of wellness programs based on the keyword or keywords; and determining a set of wellness programs based on the search. The process 400 also includes filtering the set based on sponsor data, historical success rates, and user preferences to generate a curated set of wellness programs to present to the user. Once presented to the user, the system receives the user's selection of certain wellness programs and provides an itinerary for the user. In some implementations, process 400 can be implemented on a user's computing device 205a-d (e.g., a mobile device or desktop), wherein the user's computing device 205a-d communicates with a server through a network 210.

At block 404, the system retrieves data for a particular user from the user dataset 225b. The user data may have been gathered by the system by submitting queries to the user. For example, when an employee joins an employer-sponsored physical wellness program, the system can ask the employee a few basic questions about his or her health (e.g., age, weight, specific medical conditions). The system may also solicit information about the employee via a comprehensive health survey. For example, the survey can include an extensive list of questions related to the general health and medical conditions of the employee. As part of the process of collecting information about the current conditions of the user, the system can also ask the employee for his or her goals. For example, the system may elicit health and/or lifestyle goals of the employee, such as that the employee desires to quit smoking, reduce sugar intake, or get more sleep each night.

Additionally, at block 404, the system can also gather information about the user from medical or health records. In many cases, user medical records are maintained by health care providers and are only accessible via requests made to those providers. In some cases, the system operator may have relationships with health care providers that allow for the direct transfer of health care records if approved by the user. In some cases, the system can ask the user to provide access credentials (e.g., a username and password) to allow the system to directly access the employee's medical records. If the employee grants permission, the system can access available medical information (e.g., the user's blood pressure, weight, and record of chronic conditions).

In some implementations, system may access information that is received from electronic devices associated with a user. For example, a user may have a wearable electronic device, such as a watch that monitors heart rate, and the heart rate data uploaded to the user dataset. Other information, such as number of steps, length of sleep, blood pressure, and respiratory rate of the user, may also be uploaded to the system from monitoring devices.

At block 406, based on the retrieved user data, the system places the user into a population segment that contains other users with similar characteristics. To place the user into the appropriate population segment, the system compares the retrieved characteristics of the user to the definitions of each population segment. Using a closest-fit algorithm, the system determines the population segment that most closely matches the characteristics of the user. For example, the user may be overweight, 55 years old, and a type 2 diabetic. The system matches the user data to a population segment of 50- to 60-year-old males who are overweight and have type 2 diabetes. The system's matching of a user to a population segment may be done by maintaining a list of relevant characteristics of each population segment and scoring the proximity of the user's characteristics to the population segment characteristics. User characteristics that fall within the range (e.g., within a standard deviation of a mean) of the corresponding population segment characteristics receive a higher score than user characteristics that fall outside the range of the corresponding population segment characteristics. When the scores are summed for all characteristics, the population segment having the highest score is the best match for the user.

Alternatively, in some implementations, the system can create the population segments based on identifying clusters of like users within the population of users. For example, if a company has 25,000 employees, the system can use a clustering algorithm to create segments of the employee population. By clustering employees having like conditions, the system may identify unique clusters associated with a particular employee population that might not otherwise be reflected in population segments that are generated across a broader set of workers. After clustering the employees into population segments, the user being analyzed by the system will fall within one of the resulting segments.

In general, if a user falls within more than one segment, the system can implement a tie breaking algorithm created administratively. The tie breaking algorithm may be based on the size of the segments. For example, if a user fits into three population segments, the system can place the user into the largest population segment. Alternatively, the tie breaking algorithm may be based on the severity of the condition primarily associated with the population segment.

At block 408, the system retrieves a keyword or keywords associated with the identified population segment. As described above, the population segment dataset 225d contains a description of each population segment, including a keyword or keywords that are associated with each population segment. For example, a population segment of overweight men can be associated with the keywords “weight loss” or “diabetes” or “improve fitness.” Other examples of keywords are shown in FIG. 3.

At block 410, the system searches the wellness program dataset 225d using the keyword or keywords that are associated with the user's population segment to identify wellness programs that relate to the keyword or keywords. For example, if a population segment is associated with the keywords “weight loss” and “type 2 diabetes,” the system searches the wellness program dataset 225a to identify wellness programs that are identified in the database as related to weight loss or type 2 diabetes. In response to the search query, the dataset returns a set of wellness programs that match or are related to the searched keywords.

At block 412, using the set of wellness programs that are returned by the search of the wellness program dataset 225a, the system filters the set of wellness programs based on sponsor criteria. The system retrieves sponsor criteria that is applicable to the user from the sponsor dataset 225c. The sponsor criteria that is applicable to the user is typically determined by the user's employer and/or insurance program. The sponsor criteria includes one or more rules pertaining to the wellness programs that can be offered to the user. The sponsor criteria may include positive rules, such as recommendations to promote certain wellness programs that are viewed by the sponsor to be beneficial to the user's population segment. The sponsor criteria may also include negative rules, such as types of wellness programs that the user is not eligible to access because of insurance coverage restrictions, monthly or yearly caps on services, or other restrictions. For example, an employer having a work environment in which employees participate in repetitive actions may encourage wellness programs that reduce the risk of ergonomic injuries at work. In such an example, when applying the sponsor criteria to the set of wellness programs, the system may filter the set of wellness programs to include wellness programs related to ergonomics (e.g., programs that include metadata related to “ergonomic”) and exclude programs unrelated to ergonomics (e.g., programs that exclude metadata related to “ergonomic”).

Another sponsor criteria that the system may use to filter wellness programs at block 412 is groups that the user is associated with. The metadata associated with each wellness program in wellness program dataset 225a may specify the wellness programs that are accessible to certain groups, such as employee title, location, or job role. The type of wellness program available for each group may be based on cost to deliver the wellness program, restrictions imposed by the user's health plan under which the wellness program is being offered, or other factors. Wellness programs that are prohibited to the user based on the sponsor criteria are excluded or removed from the set of wellness programs that were returned by the wellness program dataset search.

At decision block 413, the system determines whether the number of filtered wellness programs falls below a threshold value (e.g., two or three). If the number of filtered wellness programs falls below the threshold value, the system provides the identified programs to the user in a curated set at a block 418. For example, if the system determines that only two wellness programs apply to a user based on a keyword search, the system can provide the two wellness programs to the user. If the number of filtered wellness programs exceeds the threshold value, however, processing continues to block 414.

At block 414, the system filters the set of wellness programs based on the likelihood that the user will complete the wellness program. The likelihood that the user will complete the wellness program may be based on the user's past success rate in completing similar wellness programs. The system can determine that two wellness programs are similar based on the wellness programs having the same or similar associated keywords. In other words, using keywords associated with the set of wellness programs, the system can search the record of past wellness programs that were attempted and completed by the user. If the keyword search identifies many similar prior wellness programs that the user completed, the system can predict that the user will likely complete similar newly-identified programs. Conversely, if the system identifies a number of similar prior wellness programs that the user attempted and did not complete, the system can predict that the user will likely fail to complete similar newly-identified programs. Using the historical success rate information, wellness programs that are similar to wellness programs that the user has a historically lower success rate of finishing are excluded or removed by the system from the set of wellness programs that were returned by the wellness program dataset search.

If there is little or no information about the user's historical success rate with similar wellness programs, the system may instead estimate the likelihood that the user will complete the wellness program based on similarly situated users' past success rate in completing similar wellness programs. That is, the system uses success rate information from other users within the same population segment of the user. Using the historical success rate information of other similar users, wellness programs that are similar to wellness programs that the other users have a historically lower success rate of finishing are excluded or removed by the system from the set of wellness programs that were returned by the wellness program dataset search

In general, the system filters the set of wellness programs by keeping the higher-ranked wellness programs and discarding the lower-ranked wellness programs where ranking is based on historical success. Higher-ranked programs may be defined as wellness programs that are in the top quartile based on historical success rate, and lower-ranked programs may be defined as wellness programs that fall into the lower three quartiles based on historical success rate. For example, if the system has a set of ten of wellness programs at block 414, and three of the wellness programs have a success rate over 75%, and seven programs have a historical success of below 75%, the system can discard the wellness programs with historical success rates below 75%.

At block 416, the system filters the set of wellness programs based on user preferences or current user health data. In some implementations, the system retrieves user preferences from the user dataset 225b. The user data may have been gathered by the system using a questionnaire after a user completed a wellness program. The preferences retrieved by the system may indicate the type of wellness program activities or tasks that the user likes, and the type of wellness program activities or tasks that the user dislikes. Once the user's likes and dislikes are retrieved by the system, the system compares the likes and dislikes with the filtered set of wellness programs identified by the system. Wellness programs having one or more tasks that the user likes may be promoted by the system, whereas wellness programs having one or more tasks that the user dislikes may be demoted by the system. For example, a simple algorithm that the system might apply to each analyzed wellness program is to maintain a count of favorable and unfavorable tasks in the wellness program. The system may increment (+1) for each task in the wellness program that the user has indicated the user likes performing, and the system may decrement (−1) for each task in the wellness program that the user has indicated that the user does not like performing. After all likes and dislikes have been applied, the total count associated with the analyzed wellness program indicates the likely affinity of the wellness program for the user. A positive numbers indicates that a wellness programs should be left in the set of wellness program, whereas a negative number may indicate that a wellness program should be removed (or filtered) from the set of wellness programs since it contains few tasks that the user would like to perform.

In some implementations, at block 416 the system may also retrieve information about the current health of the user from the user dataset 225b. Long term health issues are typically taken into account by the system when the system places the user into a population segment. Users may experience short term or transient health conditions, however, that may also need to be taken into account by the system when recommending wellness programs. The system may therefore retrieve information about the current health of the user and use such information as part of the filtering process. For example, if the user recently broke their leg, the system may use such information to filter or remove any wellness programs that require the user to walk or jog on a daily basis. To filter based on current health conditions, the system may compare the list of current user conditions (reflected, for example, by recent coded medical procedures) with specified physical requirements associated with each wellness program. If a wellness program indicates a certain required physical or emotional characteristic that is not met by the current health of the user, the system may filter or remove that wellness program from the set of recommended wellness programs.

At block 418, the system provides a curated set of wellness programs to the user. The curated list is based on the initial set of wellness programs that are suitable for the population segment of the user identified in block 410, followed by one or more filtering functions described in blocks 412, 414, and 416. In general, the number of programs in the curated set of wellness programs is less than the number of programs available to the user. For example, the user may have access to over 150 wellness programs based on the population segment in which they are placed, but after the system filters the 150 wellness programs based on the factors above, the system may offer only 10 wellness programs that the user might enroll in.

At decision block 420, the system determines whether it received a selection of wellness programs from the user. If, at decision block 420, the system receives a selection of one or more wellness programs, the system proceeds to block 422. For example, a user may select three of the wellness programs that are displayed by the system. If, however, the system does not receive a selection of one or more wellness programs, the system continues to provide the curated set of wellness programs to the user. In some embodiments, the system may present a first portion of the curated set of wellness programs to the user. If the user does not select one or more wellness programs from the first presented portion, the system may present a second portion of the curated set of wellness programs to the user.

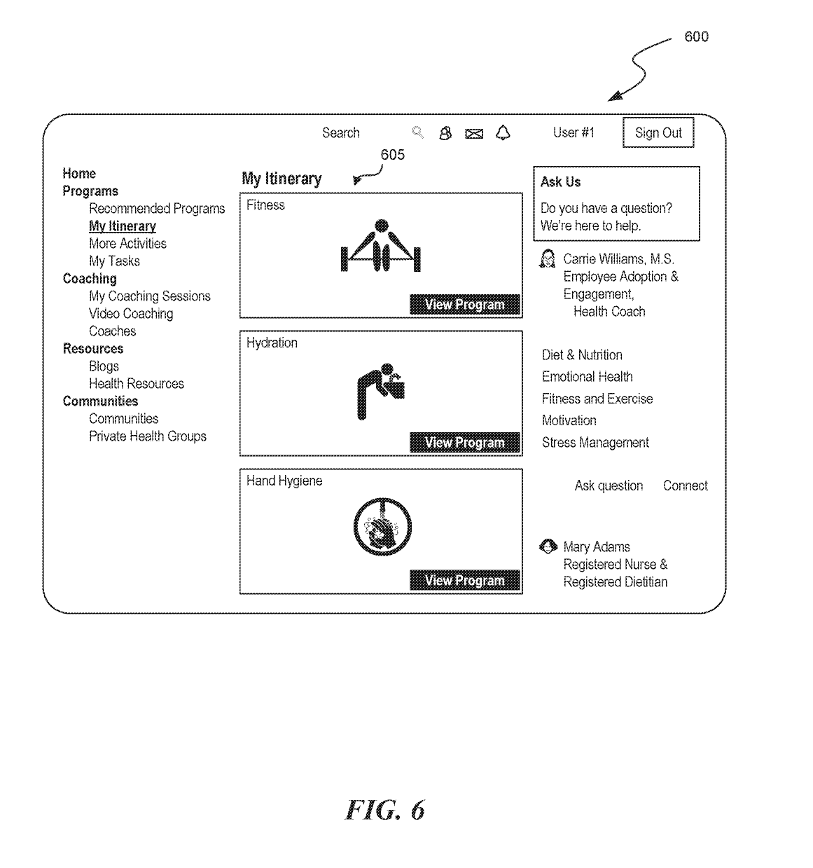

At block 422, the system places the selected wellness programs in a user itinerary. The system can display the itinerary with the selected wellness programs on a graphical interface, such as the graphical user interface 600 shown in FIG. 6. For example, device 100 can generate a graphical interface on display 130. The graphical interface may be displayed by an application, such as a smartphone application. Alternatively, the graphical interface 400 may be generated by a website and displayed on a browser application. Alternatively, the system can send an email with the itinerary to a user's preferred email address.

The aforementioned flow diagram in FIG. 4 illustrates a representative process implemented by the system to generate a curated set of wellness programs. Each block in the flow diagram may represent a module, segment, or portion of code, which comprises one or more executable instructions for implementing the specified logical function(s). It should be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It should also be noted that each block of the flow diagram in FIG. 4 and combinations of blocks in the flow diagram can be implemented by special-purpose hardware-based systems that perform the specified functions or by combinations of special-purpose hardware and computer instructions. Additionally, in some alternative implementations, some functions may be omitted or skipped. For example, the system can execute the process 400 without filtering based on historical success or user preferences (blocks 414 or 416).

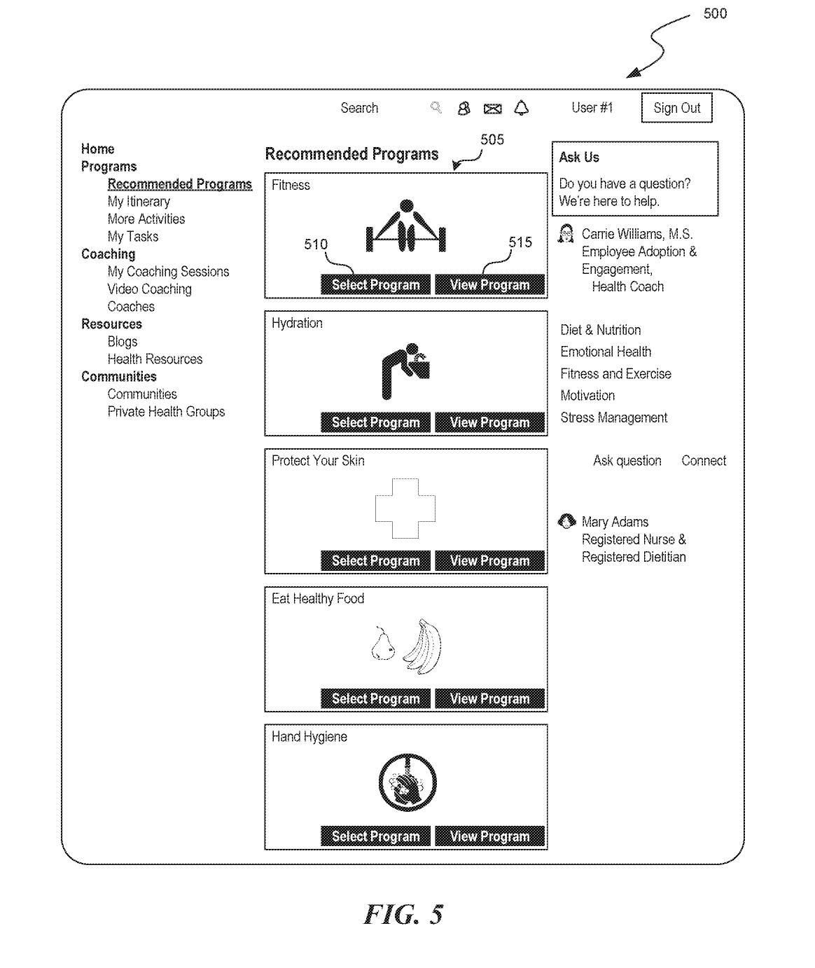

Once the system presents the curated set of wellness programs to the user, the selects one or more wellness programs in which to enroll. FIG. 5 is a graphical user interface 500 that is generated by the system, from which the user can select recommended wellness programs. The center of the display includes a “recommended programs” region 505. The recommended programs region 505 depicts five wellness programs that the system has curated for the user. The five recommended wellness programs presented to the user in FIG. 5 are fitness, hydration, hand hygiene, protecting skin, and eating healthy food. The user can select a program to place in an itinerary by pressing a “select program” button 510. If a user wants to learn more about a program, the user can press a “view program” button 515. In response to pressing the “view program” button, the system can display information about the program such as a description, duration, and typical tasks for the selected wellness program. The user can use this information to further determine if he or she wants to enroll in a particular wellness program.

Even though the system could have displayed many more wellness programs to the user in the graphical interface 500, the system displays a limited number of recommended programs that relate to the population segment of the user, sponsor criteria, likelihood that a user will completes the displayed wellness programs, and user preferences, as described above. By limiting the number of recommended wellness programs displayed to a user, the user is not overwhelmed with too many choices. Also, by recommending programs with historical success and incorporating user preferences, the system is likely to identify wellness programs that the user will select, enjoy, and ultimately complete.

As shown in graphical interface 500, the left side of graphical interface 500 has interactive buttons or widgets that a user can select to view particular information, such as wellness programs in which the user is currently enrolled or coaching sessions the user has viewed or should view to complete a task for a wellness program. Also, the left side of graphical interface 500 includes resources the user can access, such as blogs and other health resources such as articles or websites. The right side of graphical interface 500 includes other interactive buttons and widgets for the user.

FIG. 6 includes a graphical interface 600 that is generated by the system. A user can view graphical interface 600 after he or she has enrolled in one or more wellness programs. For example, after a user has enrolled in a few wellness programs, the user can select “my itinerary” on the left of side of graphical interface 600. The center of the display includes an “itinerary” region 605. The depicted itinerary region 605 includes three wellness programs that the user has enrolled in, namely fitness, hydration, and hand hygiene. Comparing graphical interface 500 to graphical interface 600, the user chose to enroll in three wellness programs (fitness, hydration, and hand hygiene) and did not enroll in two other programs on the recommended list (protecting skin and eating healthy food). In general, the system provides graphical interface 600 to a user so that he or she can view and interact with the user itinerary.

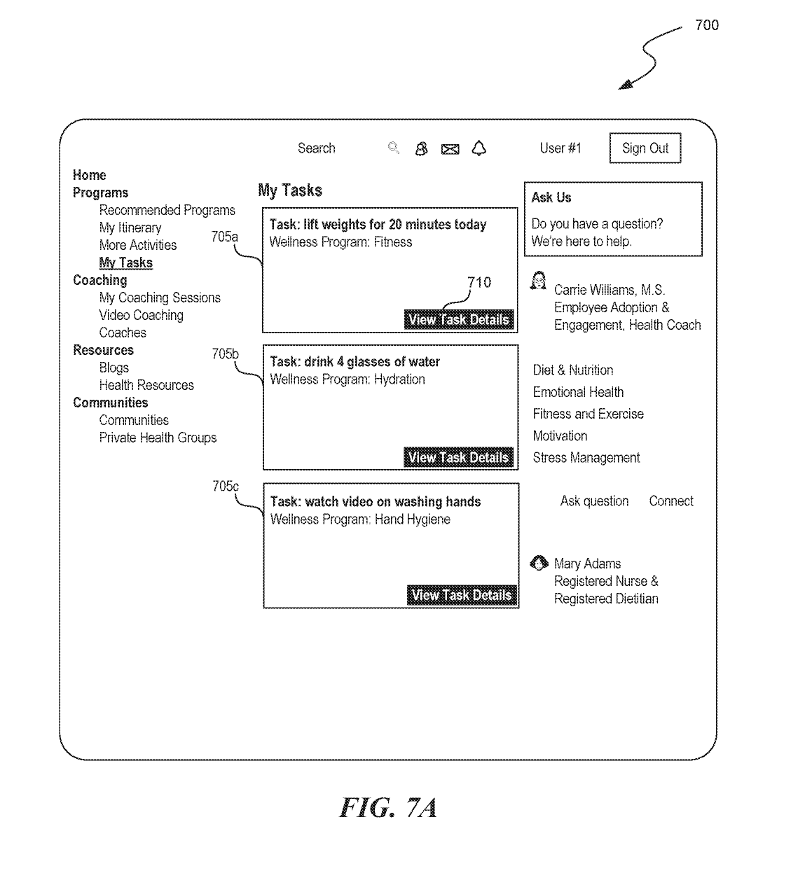

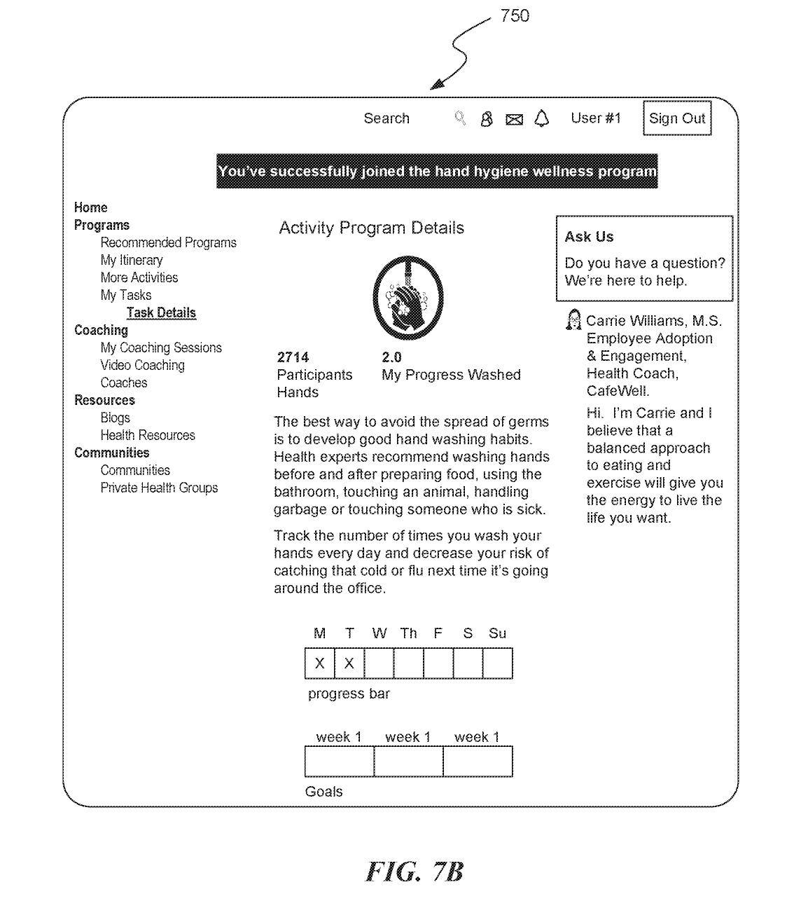

In addition to viewing an itinerary, a user can view tasks associated with the itinerary. FIG. 7A is a using graphical interface 700 generated by the system to allow the user to see outstanding tasks in selected wellness programs. Each wellness program in the user's itinerary may have one or more tasks that are to be performed. In the depicted example, each wellness program has a single tasks 705a-705c. For the fitness wellness program, the user has a task 705a that includes lifting weights for 20 minutes on a particular day. If a user wants to know more information about the task, such has how to lift weights, the user can select a “view task details” button 710 to learn more about the task. Other tasks for the user include watching a video on washing hands 705b (associated with the hand hygiene wellness program as shown in FIG. 6) and drinking four glasses of water 705c as part of the hydration wellness program. In general, a user can use the left side of graphical user interface 700 to switch between a task screen (FIG. 7A), recommended programs (FIG. 5), and the user's current itinerary (FIG. 6).

Along with providing a graphical interface to view an itinerary, the system allows the user to view progress within each wellness program. FIG. 7B is a graphical user interface 750 that is generated by the system for viewing wellness program progress. In the depicted interface 750, the user is shown his or her progress related to the hand hygiene wellness program. For example, the user can see that he or she successfully completed the task of washing his or her hands on Monday and Tuesday, but he or she still needs to wash his or her hands the rest of the week to complete the goal for the week. In general, the system can provide activity wellness program details for each wellness program in which a user is enrolled.

From the foregoing, it will be appreciated that specific implementations of the invention have been described herein for purposes of illustration, but that various modifications may be made without deviating from the scope of the technology. Accordingly, the technology is not limited except as by the appended claims.

I/We claim:

1. A method implemented by a computing system to recommend wellness programs to users, the method comprising:
maintaining a dataset of wellness programs that are available for enrollment by users, each wellness program comprising one or more tasks that are performed by a user;
maintaining data characterizing sponsors of wellness program, each sponsor having criteria specifying one or more wellness programs that are available to users associated with that sponsor;
receiving data characterizing a user, the user data comprising age, gender, and health information about the user;
assigning the user to a population segment based on the received data characterizing the user;
identifying a plurality of wellness programs that are suitable for the assigned population segment of the user;
filtering the identified plurality of wellness programs based on one or more factors to generate a recommended set of wellness programs; and
providing the recommended set of wellness programs to the user.

2. The method of claim 1, wherein identifying the plurality of wellness programs is based on keyword searching.

3. The method of claim 1, wherein the population segment is generated by:
identifying a population of users that includes the user; and
clustering the population of users to generate a plurality of population segments that includes the population segment.

4. The method of claim 1, wherein criteria for assigning the user to the population segment is provided by an industry group.

5. The method of claim 1, wherein the data characterizing the user is received from a service that maintains health information of the user.

6. The method of claim 1, wherein the one or more factors are selected from the group consisting of: sponsor criteria associated with the user, a likelihood of success of the user in a wellness program, or user preferences.

7. The method of claim 6, wherein user preferences are derived from responses to one or more queries to the user after the user completed a wellness program.

8. The method of claim 6, wherein the likelihood of success of the user in a wellness program is based on the successful completion of similar wellness programs by other users in the population segment to which the user is assigned.

9. The method of claim 6, wherein the likelihood of success of the user in a wellness program is based on the user successfully completing similar wellness programs.

10. The method of claim 6, wherein the sponsor criteria include the cost of the wellness program.

11. The method of claim 1, further comprising:
receiving a selection of a wellness program or programs from a user; and
in response to receiving the selection, providing an itinerary of enrolled wellness programs to the user.

12. A tangible computer-readable storage medium containing instructions that, when executed by one or more processors, perform a method to recommend wellness programs to users, the method comprising:
maintaining a dataset of wellness programs that are available for enrollment by users, each wellness program comprising one or more tasks that are performed by a user;
maintaining data characterizing sponsors of wellness program, each sponsor having criteria specifying one or more wellness programs that are available to users associated with that sponsor;
receiving data characterizing a user, the user data comprising age, gender, and health information about the user;
assigning the user to a population segment based on the received data characterizing the user;
identifying a plurality of wellness programs that are suitable for the assigned population segment of the user;
filtering the identified plurality of wellness programs based on one or more factors to generate a recommended set of wellness programs; and
providing the recommended set of wellness programs for the user.

13. The tangible computer-readable storage of claim 12, wherein identifying the plurality of wellness programs is based on keyword searching.

14. The tangible computer-readable storage of claim 12, wherein the population segment is generated by:
identifying a population of users that includes the user; and
clustering the population of users to generate a plurality of population segments that includes the population segment.

15. The tangible computer-readable storage of claim 12, wherein criteria for assigning the user to the population segment is provided by an industry group.

16. The tangible computer-readable storage claim 12, wherein the data characterizing the user is received from a service that maintains health information of the user.

17. The tangible computer-readable storage of claim 12, wherein the one or more factors are selected from the group consisting of: sponsor criteria associated with the user, a likelihood of success of the user in a wellness program, or user preferences.

18. The tangible computer-readable storage of claim 17, wherein user preferences are derived from responses to one or more queries to the user after the user completed a wellness program.

19. The tangible computer-readable storage of claim 17, wherein the likelihood of success of the user in a wellness program is based on the successful completion of similar wellness programs by other users in the population segment to which the user is assigned.

20. The tangible computer-readable storage of claim 17, wherein the likelihood of success of the user in a wellness program is based on the user successfully completing similar wellness programs.

21. The tangible computer-readable storage of claim 12, wherein receiving data characterizing the user further comprises:
receiving data characterizing the user from a third party database, wherein the third party is different from the sponsors having wellness programs; and
including the received data characterizing the user in assigning the user to a population segment.
